(19) United States
(12) Patent Application Publication
(10) Pub. No.: US 2013/0166804 A1
(43) Pub. Date: Jun. 27, 2013

(54) INFORMATION PROCESSING APPARATUS AND RECORDING APPARATUS USING THE SAME

(71) Applicant: CANON KABUSHIKI KAISHA, Tokyo (JP)

(72) Inventors: Eriko Nishitani, Tokyo (JP); Satoshi Kitai, Kawasaki-shi (JP)

(73) Assignee: CANON KABUSHIKI KAISHA, Tokyo (JP)

(21) Appl. No.: 13/718,290

(22) Filed: Dec. 18, 2012

(30) Foreign Application Priority Data
Dec. 21, 2011 (JP) PCT/JP2011/079586

(51) Int. Cl. G06F 13/24

(52) U.S. Cl. CPC G06F 13/24
USPC 710/267

(57) ABSTRACT

A memory control unit is connected to a first bus and a second bus and that controls writing and reading of data to a memory; a control unit controls the information processing apparatus; a first circuit device is connected to the first bus and outputs a data write request to the memory control unit and a notification signal; a second circuit device is connected to the first bus and outputs a data read request to the memory control unit in accordance with the notification signal and an interrupt signal to the control unit in response to the data read request; and a third circuit device is connected to the second bus and outputs a data read request stored in the memory to the memory control unit in accordance with an instruction from the control unit which has received an interrupt signal.

### TECHNICAL FIELD

The present invention relates to an information processing apparatus and a recording apparatus using the same, and more specifically to control of access to a memory.

### BACKGROUND ART

PTL 1 describes that a configuration for guaranteeing the access order in which data is read from a memory and data is written to a memory is provided, in which, to determine whether or not an input read request and a write request which specifies an address that matches an address specified by the read request are present, the read request is temporarily registered in a buffer, it is determined whether or not a write request which specifies an address that matches an address from which data is read is present, and if a write request to a matching address is present and a wait is necessary, a flag indicating whether or not a wait is necessary is issued, so that the write request is preceded.

### CITATION LIST

### Patent Literature

PTL 1 Japanese Patent Laid-Open No. 2001-331363

However, considering a system configuration as illustrated in FIG. 13, which has a plurality of buses 2 and 3 connected to a memory 20 and which includes a bus master 4 connected to the bus 2 and a bus master 5 connected to the bus 3, the following three problems arise.

The first problem is that due to access to a memory via buses having different protocols, it is necessary to implement address comparison circuits in accordance with the respective bus protocols. This increases the complexity of an order guarantee circuit, resulting in an increase in the size of the order guarantee circuit.

The second problem is that inconsistency occurs between bus masters having different connections in terms of a write operation and a read operation. This inconsistency will be described below. In the system in FIG. 13, the bus master 4 outputs data 21 and a write request 16 to store them in the memory 20. The data 21 is stored in a buffer 8 provided midway while the data 21 is transferred along a bus. After outputting the data, the bus master 4 outputs an interrupt signal 14 to an interrupt signal control circuit 9. The interrupt signal control circuit 9 transmits a notification signal 15 to a CPU 2. The CPU 2 instructs the bus master 5 to read data written to the memory 2 by the bus master 4, in accordance with a predetermined procedure.

In response to an instruction from the CPU 2, the bus master 5 outputs a read request 17 for reading the data 21 from the memory 20, and reads (18) the data from a predetermined address (address 1000) of the memory 20. However, as illustrated in FIG. 13, the data 21 that should be stored at the predetermined address (address 1000) of the memory 20 is still in a state of being held in the buffer 8. This state occurs when the processing for the bus 3 (read request 17) has taken precedence over the processing for the bus 2 (write request 16). In this way, since data 23 which has been stored prior to the data 21 to be read is read by the bus master 5 through a buffer 6, the bus master 5 is not allowed to read the desired data 21. Thus, data inconsistency occurs. Such inconsistency occurs when the read request 17 is transmitted to a memory earlier than the write request 16 in accordance with the priority of access of a bus to the memory.

The third problem is that ensuring a time period required for the read operation to be executed a plurality of times or for the write processing to be completed in order to guarantee the access order under software control results in an increase in the processing time for accessing the memory and a reduction in the real-time performance.

The present invention has been made in view of the foregoing problems, and an object thereof is to provide an information processing apparatus which can guarantee an order in which a memory is accessed.

### SUMMARY OF INVENTION

In order to solve the problems described above and to achieve the object, an information processing apparatus of an example of the present invention is an information processing apparatus including a memory control unit that is connected to a first bus and a second bus and that controls writing of data to a memory and reading of data from the memory. The information processing apparatus includes a control unit that controls the information processing apparatus; a first circuit device that is connected to the first bus and that outputs a data write request to the memory control unit and outputs a notification signal; a second circuit device that is connected to the first bus and that outputs a data read request to the memory control unit in accordance with the notification signal and outputs an interrupt signal to the control unit in accordance with a response to the data read request; and a third circuit device that is connected to the second bus and that outputs a data read request stored in the memory to the memory control unit in accordance with an instruction from the control unit which has received an input of the interrupt signal.

Further features of the present invention will become apparent from the following description of exemplary embodiments with reference to the attached drawings.

### BRIEF DESCRIPTION OF DRAWINGS

FIG. 1 is a block diagram of an information processing apparatus in a first embodiment.

FIG. 2 is an explanatory diagram of the timing of data access in the configuration in FIG. 1.

FIG. 3 is an explanatory diagram of the operation timing of an order guarantee circuit in the configuration in FIG. 1.

FIG. 4A is an explanatory diagram of processing performed by a memory controller.

FIG. 4B is an explanatory diagram of processing performed by the memory controller.

FIG. 5A is a diagram depicting arbitration performed by an arbiter.

FIG. 5B is a diagram depicting arbitration performed by an arbiter.

FIG. 6 is a block diagram of an information processing apparatus in an embodiment.

FIG. 7 is an explanatory diagram of the operation timing of an order guarantee circuit in an embodiment.

FIG. 8 is a block diagram of an information processing apparatus in an embodiment.

FIG. 9 is an explanatory diagram of the operation timing of an order guarantee circuit in an embodiment.

FIG. 10 is a block diagram of an information processing apparatus in an embodiment.

FIG. 11 is an explanatory diagram of the operation timing of an order guarantee circuit in an embodiment.

FIG. 12 is a perspective view of a recording apparatus.

FIG. 13 is a diagram depicting problems.

### DESCRIPTION OF EMBODIMENTS

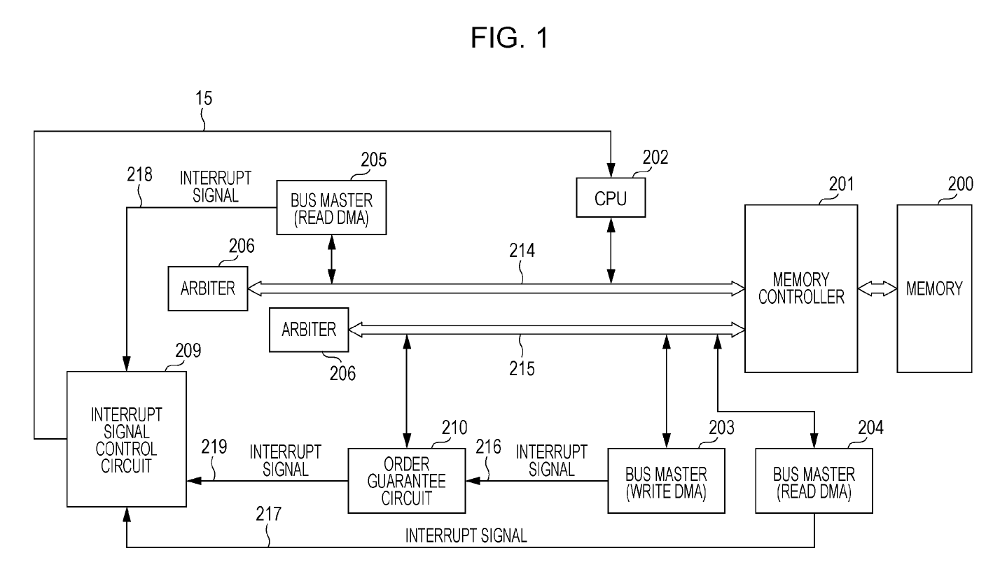

Next, embodiments of the present invention will be described in detail using the drawings. FIG. 1 schematically illustrates a circuit configuration of an information processing apparatus. In FIG. 1, the information processing apparatus mainly includes, as circuit devices (also referred to as circuit blocks), a CPU 202, an interrupt signal control circuit 209, a memory 200, a memory controller (memory control unit) 201, bus masters 203 and 205, an order guarantee circuit 210, and arbiters 206. The CPU 202 controls the information processing apparatus. A control unit of the information processing apparatus includes the CPU 202 and the interrupt signal control circuit 209. As illustrated in FIG. 1, the circuit devices (circuit blocks) described above are connected to a bus 214 and a bus 215. The arbiters (arbitration units) 206 arbitrate requests for accessing the memory 200 (write request, read request) from the circuit blocks. Upon receiving an input of an interrupt signal, the interrupt signal control circuit 209 transmits a notification signal 15 to the CPU 202. The CPU 202 sends an instruction for accessing the memory 200 to the bus masters 203 and 205. To avoid complexity of FIG. 1, the illustration of a signal line from the CPU 202 to the bus master 203 and a signal line from the CPU 202 to the bus master 205 is omitted for convenience of illustration. For a similar reason, the illustration of a memory or the like that holds a program to be executed by the CPU 202 is also omitted. The bus master 203 includes a write DMA means, and the bus master 205 includes a read DMA means. The write DMA means is a transfer means for performing DMA (direct memory access) transfer to store data in a memory. The data transfer method is not limited to DMA transfer, and any other method may be used. The read DMA means is a transfer means for performing DMA (direct memory access) transfer when reading data from a memory. Since the information processing apparatus is generally provided with a plurality of bus masters, as illustrated in FIG. 1, a bus master 204 is connected to the bus 215. If the information processing apparatus is a recording apparatus or an image reading apparatus, the above bus masters are, for example, circuit blocks for processing image data. Examples of the processing of image data include color conversion processing for converting color components of red (R), green (G), and blue (B) into color components of cyan (C), magenta (M), yellow (Y), and black (K). Other examples include multilevel-to-binary conversion processing for converting multilevel data into binary data, decimation processing of image data, aspect conversion processing of image data, and expansion processing of compressed data. In addition, the bus masters are also used for circuit blocks for controlling drive circuits of a motor, a recording head, and a read sensor. Such circuit blocks process drive data of the motor and the recording head.

The arbiters 206 respectively arbitrate the orders of memory access of the circuit blocks connected to the buses 214 and 215. The arbitration includes, when access requests (write, read) are simultaneously issued from the circuit blocks, accepting the requests of the circuit blocks in a predetermined order. Arbitration methods include a round-robin method in which priorities are changed in sequence and a method in which priorities are fixed.

The memory controller 201 is a circuit block that controls access to the memory 200. As illustrated in FIG. 1, the memory controller 201 is connected to the two buses 214 and 215. The priority levels of access requests of the buses 214 and 215 to the memory 200 are determined by the setting of the memory controller 201. The memory controller 201 enables access (write, read) to the bus 214 and the bus 215 in a time division manner in accordance with the set priority levels. In other words, the memory controller 201 switches connection between the two buses 214 and 215 in a time division manner. The memory controller 201 stores data transferred via an enabled bus in the memory 200, and reads and outputs data stored in the memory 200 to the bus. The memory controller 201 and the arbiters 206 are provided with a buffer, if necessary, for storing requests of circuit blocks in order.

Next, the access between a circuit device (circuit block) and a memory will be described. Upon receiving an instruction from the CPU 202, the bus master 205 reads data written to an address H1000 in the memory 200 by the bus master 203, and performs predetermined processing based on the data.

Next, the role of the order guarantee circuit 210 will be described. The bus master 203 outputs data to the bus 215 to write the data. After outputting the data, the bus master 203 outputs an interrupt signal 216 to the order guarantee circuit 210 as a notification signal. Upon receiving an input of the interrupt signal 216, the order guarantee circuit 210 reads data via the bus 215. After performing this reading operation, the order guarantee circuit 210 outputs an interrupt signal 219 to the interrupt signal control circuit 209 as a notification signal. The interrupt signal control circuit 209 outputs a notification signal 15 to the CPU. The CPU 202 instructs the bus master 205 to read the data from the memory 200 in accordance with the notification signal 15. The bus master 205 performs a data read request. The above control configuration ensures that the bus master 205 can read the data stored in the memory 200 by the bus master 203. Consistency of data to be written and read by devices can be guaranteed regardless of the priority levels of access of the memory controller 201 to buses or whether the data is stored in a buffer.

For example, if the order guarantee circuit 210 receives from the memory controller 201 a response signal in response to the read request output from the order guarantee circuit 210, the order guarantee circuit 210 determines that data has been successfully read from the memory 200. Alternatively, the order guarantee circuit 210 determines that data has been successfully read from the memory 200 if the order guarantee circuit 210 receives the data. If the response signal described above or data has not been successfully received, the order guarantee circuit 210 can regard the data output from the bus master 203 to the bus 215 as having not yet been stored in the memory 200.

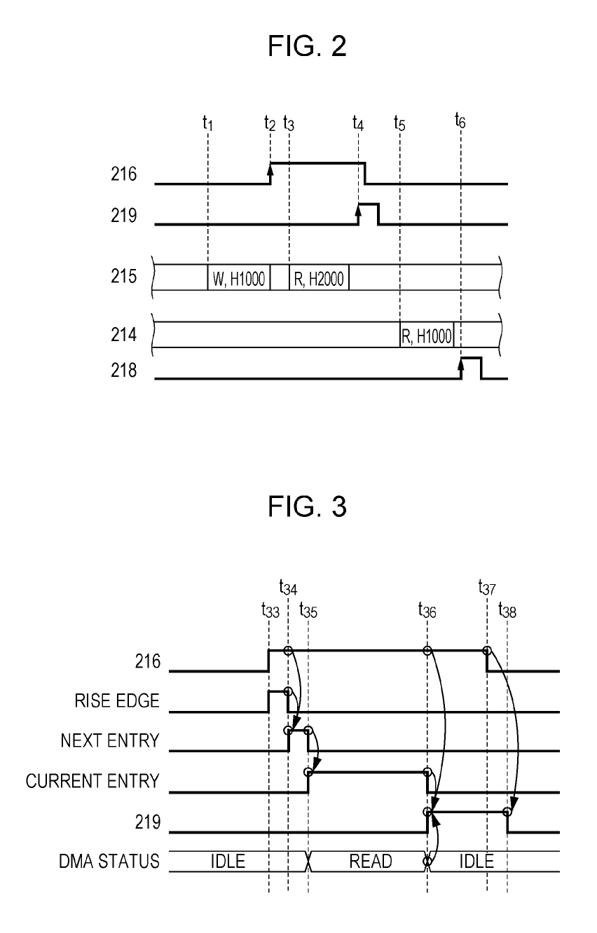

FIG. 2 is a diagram depicting the timing of data on the buses and the interrupt signals in the circuit configuration in FIG. 1. In FIG. 2, numbers on the left part correspond to the interrupt signals 216, 218, and 219 and the buses 214 and 215 illustrated in FIG. 1. The bus master 203 outputs, as a write request, a write instruction (W) to the address H1000 of the memory 200 to the bus 215 (timing t1). After that, the bus master 203 outputs the interrupt signal 216 (timing t2). After receiving the interrupt signal 216, the order guarantee circuit 210 outputs, as a read request, a read instruction (R) from an address H2000 of the memory 200 (timing t3). If the order guarantee circuit 210 has successfully read data from the memory 200, the order guarantee circuit 210 outputs the interrupt signal 219 (timing t4). If the interrupt signal 219 is input to the interrupt signal control circuit 209, the CPU 202 outputs an operation instruction to the bus master 205. In accordance with the instruction from the CPU 202, the bus master 205 outputs a read instruction (R) from the address H1000 of the memory 200 (timing t5). When the reading operation is completed, the bus master 205 outputs an interrupt signal 218 (timing t6).

The address of the memory specified by the order guarantee circuit 210 may be an address different from the address specified by the bus master 203. The reason for this is that the address from which data is read and the data to be read itself are not meaningful, and it is a purpose to access the memory 200 via the bus 215. In addition, a write request and a read request may be output from circuit devices to a memory controller using a special signal line for write requests and a special signal line for read requests.

Next, the operation of the order guarantee circuit 210 will be described using FIG. 3. Numeral 216 corresponds to the interrupt signal 216 in FIG. 1, and numeral 219 corresponds to the interrupt signal 219 in FIG. 1. Rise edge, next entry, and current entry are signal names in the order guarantee circuit 210. DMA status indicates the internal state of the order guarantee circuit 210. When the interrupt signal 216 from the bus master 203 is input to the order guarantee circuit 210 (timing t33), the rise of the interrupt signal 216 is detected, and the rise edge goes to a high level. Then, the rise edge goes to a low level. Upon detection, the interrupt signal 216 is stored in the next entry (timing t34). If there is no other entry signal, the next entry immediately transitions to the current entry, and the DMA status transitions from idle to read (read DMA is issued to an arbitrary address) (timing t35). In the DMA status of read, a read DMA operation has been executed. The read DMA operation is an operation performed during a period from when a read request is issued to when data is read from the memory 200. Thus, the completion of the read DMA operation for the memory 200 can be regarded as data having been written to the memory 200 by the immediately preceding write DMA operation performed by the bus master 3. This read DMA operation ensures that the completion of data transfer to the memory is guaranteed.

After the read DMA operation performed by the order guarantee circuit 210 is completed, the DMA status transitions to idle, and the interrupt signal 219 to be output to the interrupt signal control circuit 209 is issued (timing t36). Upon receiving the interrupt signal 219, the interrupt signal control circuit 209 sends a notification to the CPU 202. Then, under control of the CPU 202, a read request or a write request from the subsequent bus master is issued. When the change of the interrupt signal 216 from the bus master 203 from a high level to a low level is detected (timing t37), the interrupt signal 219 is also changed from a high level to a low level (timing t38).

The number of times the order guarantee circuit 210 performs the read DMA operation is determined in accordance with a bus arbitration method. When at least two of the bus master 203, the bus master 204, and the order guarantee circuit 210 simultaneously make requests to a memory controller, the arbitration of buses defines the processing order of the requests.

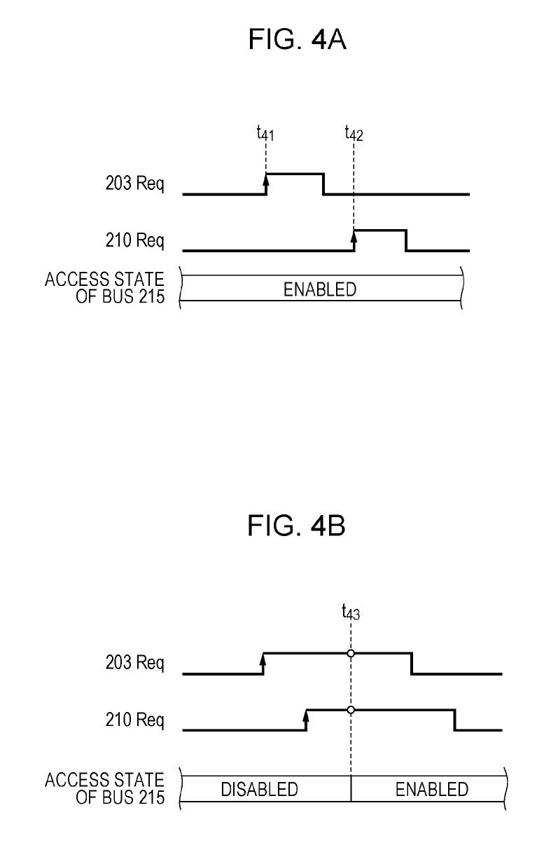

The case where two requests are simultaneously made to a memory controller will be described using FIGS. 4A and 4B. As illustrated in FIG. 4A, while the memory controller 201 enables access to the bus 215, the bus master 203 outputs an access request (203 Req) (timing t41). After that, if the order guarantee circuit 210 outputs an access request (210 Req) (timing t42), the memory controller can determine that the bus master 203 has made an access request to the memory controller earlier than the order guarantee circuit 210. However, as illustrated in FIG. 4B, if the 210 Req is output after the 203 Req while the memory controller 201 disables access to the bus 215, it is determined that the 203 Req and the 210 Req have been simultaneously output. The reason for this is that the memory controller 201 changes the state of access to the bus 215 from disabled to enabled at a timing t43 after the 203 Req and the 210 Req are output.

In the case of bus arbitration of the round-robin method, the read DMA operation is performed twice. In contrast, in the case of bus arbitration of the fixed priority method, if the priority of the order guarantee circuit 210 is lower than the priority of the bus master 203, the read DMA operation is performed once.

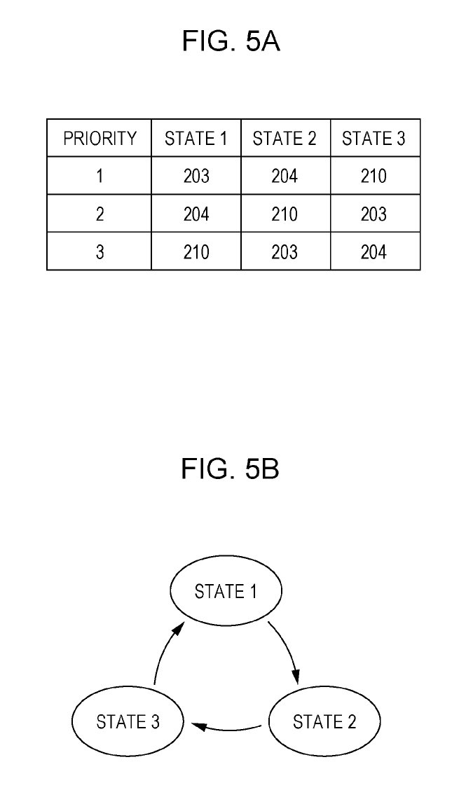

FIGS. 5A and 5B are diagrams depicting the round-robin method in terms of bus arbitration priority. In the round-robin method, a bus master given the first priority to use a bus is given the lowest priority to use the next bus. In this way, first priority to use buses is sequentially given to bus masters. As illustrated in FIG. 5A, three states having set priorities are defined. For example, in state 1, the priority of the request made by the bus master 203 is the highest and the priority of the request made by the bus master 204 is the second highest. The priority of the request made by the order guarantee circuit 210 is the third highest (or lowest). As illustrated in FIG. 5B, when a command is accepted and processed in the state 1, the state changes from the state 1 to the state 2. By repeating this processing, it is possible to equalize the opportunities of increasing the priority of the three circuit blocks.

The reason that the read DMA operation is performed twice in the round-robin method is as follows. In the case of the state 2 and the state 3 in FIGS. 5A and 5B, the read DMA operation performed by the order guarantee circuit 210 for the first time is not processing performed after the writing performed by the bus master 203, and therefore the order guarantee described above is not achievable. Thus, the read DMA operation is performed for the second time so that the read DMA operation is performed after the writing performed by the bus master 203. In this way, in a case where bus arbitration is performed using the round-robin method, the order guarantee circuit 210 outputs a read request at least twice. On the other hand, in a case where bus arbitration is performed with a state maintained in which the priority of the bus master 203 is higher than the priority of the order guarantee circuit 210 (fixed priority method), the order guarantee circuit 210 may be only required to output a read request once.

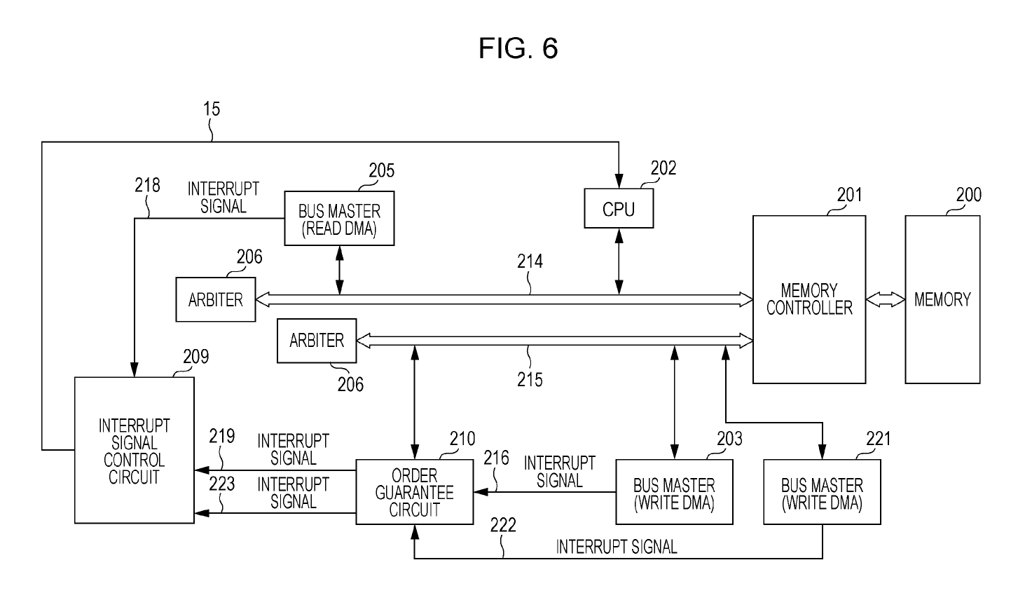

FIG. 6 depicts a second embodiment of an information processing apparatus. A description of the same configuration as that in the first embodiment will be omitted, and a description will be made of a different point. In FIG. 6, a bus master 221 is connected to the bus 215. The bus master 221 includes a write DMA means. Thus, similarly to the bus master 203, the bus master 221 outputs an interrupt signal 222 to the order guarantee circuit 210. The order guarantee circuit 210 outputs interrupt signals 219 and 223 to the interrupt signal control circuit 209.

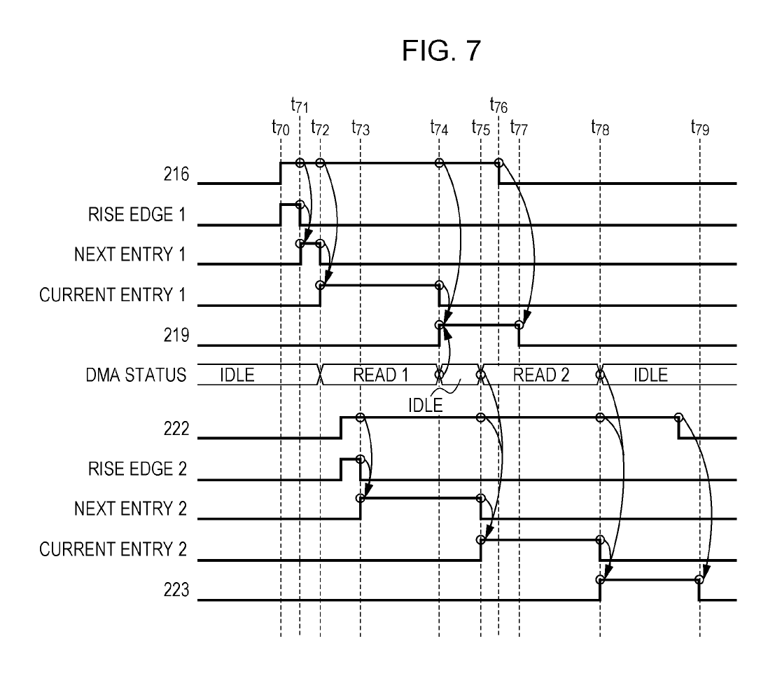

FIG. 7 is an explanatory diagram of the operation of the order guarantee circuit 210 in the configuration in FIG. 6. In FIG. 7, numerals 216, 219, 222, and 223 correspond to the signal 216, the signal 219, the signal 222, and the signal 223 in FIG. 6, respectively. A description of an operation similar to that in the first embodiment will be omitted. FIG. 7 is a diagram depicting the operation timing in a case where the order guarantee circuit 210 accepts the interrupt signal 216 earlier than the interrupt signal 222. A description of an operation similar to that in the first embodiment will be omitted. The order guarantee circuit 210 performs processing of rise edge 1, next entry 1, and current entry 1. The DMA status of the order guarantee circuit 210 transitions from idle to read 1 (timing t72), and the read DMA operation is performed. After that, the order guarantee circuit 210 outputs an interrupt signal 219, and the DMA status of the order guarantee circuit 210 transitions from read 1 to idle (timing t74). On the other hand, upon detecting an interrupt signal 222 at the timing during which the read DMA operation is executed, the order guarantee circuit 210 performs processing of rise edge 2 and next entry 2. When the order guarantee circuit 210 performs processing of the current entry, the DMA status transitions from idle to read 2 (timing t75), and the read DMA operation is executed. An interrupt signal 223 is output.

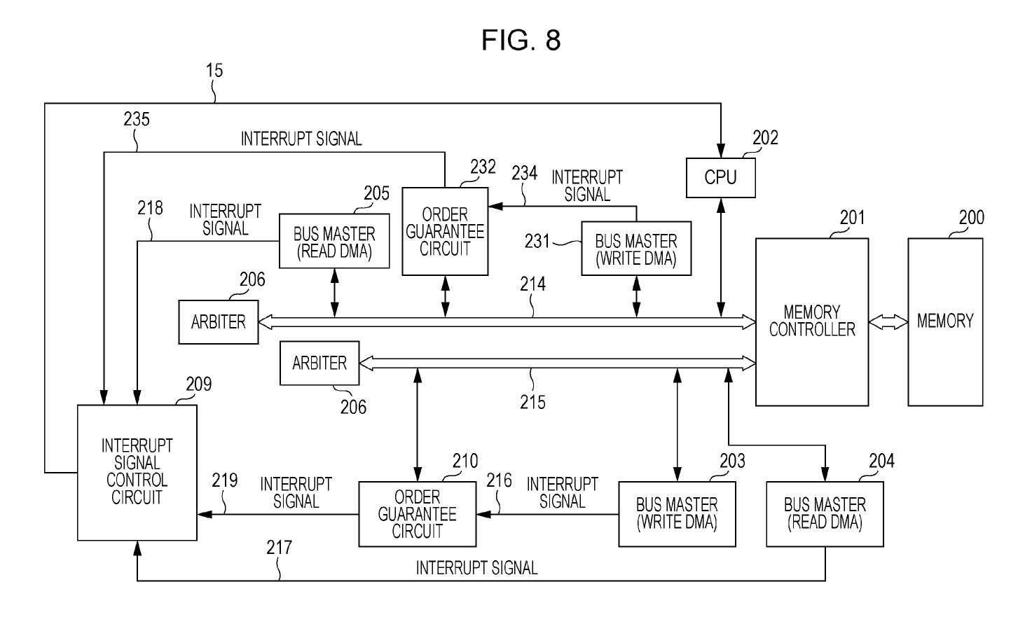

FIG. 8 depicts a third embodiment of an information processing apparatus. A description of the same configuration as that in the first embodiment will be omitted, and a description will be made of a different point. In FIG. 8, a bus master 231 and an order guarantee circuit 232 are connected to the bus 214. An arbiter 206 is connected to the bus 214. The bus master 231 includes a write DMA means. Similarly to the bus master 203, the bus master 231 outputs an interrupt signal 234 to the order guarantee circuit 232. The order guarantee circuit 232 outputs an interrupt signal 235 to the interrupt signal control circuit 209. In this way, if a circuit block that performs writing to a memory is connected to a certain bus, an order guarantee circuit is connected to the bus.

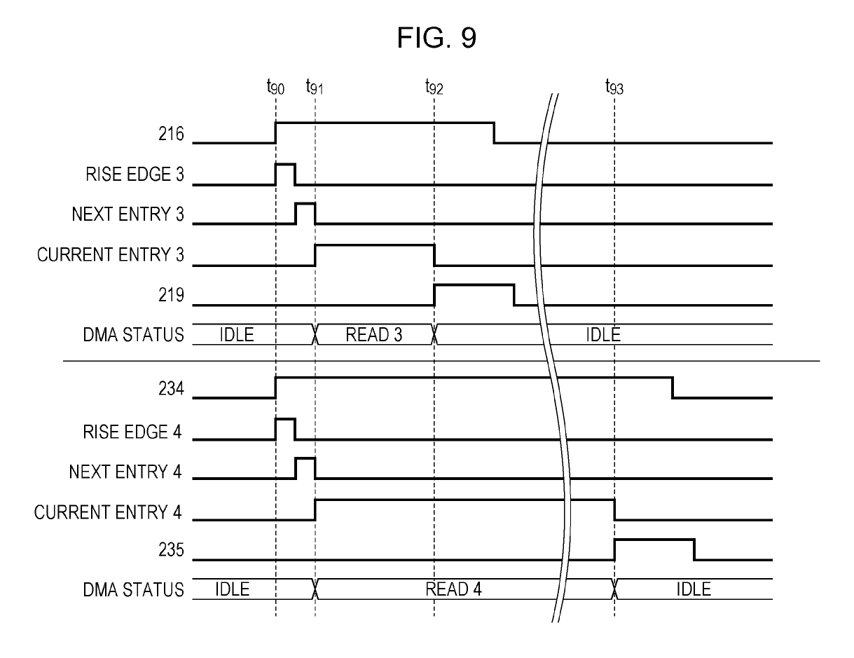

FIG. 9 is an explanatory diagram of the operation of the order guarantee circuits 210 and 232 in the configuration in FIG. 8. The operation of the order guarantee circuit 210 is illustrated in the upper part of FIG. 9, and the operation of the order guarantee circuit 232 is illustrated in the lower part of FIG. 9. In FIG. 9, numerals 216, 219, 234, and 235 correspond to the signal 216, the signal 219, the signal 234, and the signal 235 in FIG. 8, respectively. A description of an operation similar to that in the first embodiment will be omitted. The bus master 203 and the bus master 231 output a write request. At timing t90, the order guarantee circuit 210 receives an input of an interrupt signal 216, and the order guarantee circuit 232 receives an input of an interrupt signal 234. Since the memory controller 201 has accepted the read request of the order guarantee circuit 210 earlier than the read request of the order guarantee circuit 232, the order guarantee circuit 210 prior to the order guarantee circuit 232 performs a read DMA operation. The DMA status transitions from idle to read 3 at timing t91, and transitions from read 3 to idle at timing t92. For a period during which the order guarantee circuit 210 performs a read DMA operation (timings t91 to t92), the order guarantee circuit 232 is waiting for a bus to respond. The order guarantee circuit 232 performs a read operation for a long period from the issuance of a read request (timing t91) to the completion of reading (timing t93).

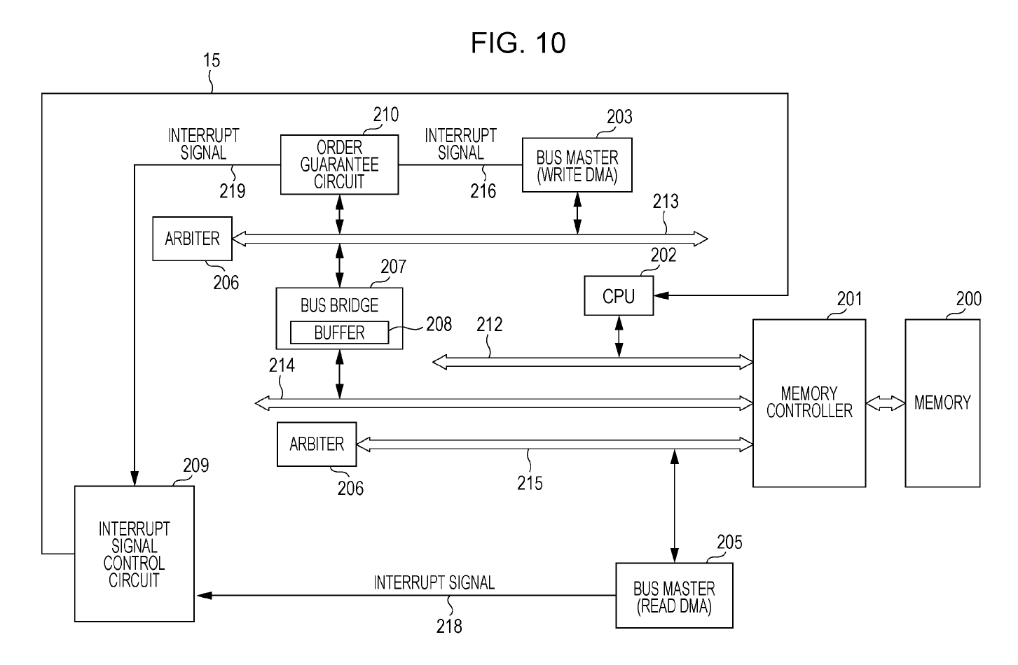

FIG. 10 depicts a fourth embodiment of an information processing apparatus. A description of the same configuration as that in the first embodiment will be omitted, and a description will be made of a different point. As illustrated in FIG. 10, three buses are connected to the memory controller 201. Since the protocol of a bus 213 is different from the protocol of a bus 214, the bus 213 and the bus 214 are connected to each other via a bus bridge 207. The bus master 203 and the order guarantee circuit 210 are connected to the bus 213. The bus master 203 outputs data to the bus 213 to write the data. The data output to the bus 213 is transferred to the bus 214 via the bus bridge 207, and is transferred to the memory controller 201. The bus bridge 207 includes a buffer 208, and the data output from the bus master 203 is also temporarily held in the buffer 208. Also in this system configuration, upon receiving an input of an interrupt signal 216, the order guarantee circuit 210 outputs a read request, and reads data from the memory 200 via the bus 214, the bus bridge 207, and the bus 213. After reading the data, the order guarantee circuit 210 outputs an interrupt signal 219 to the interrupt signal control circuit 209. Accordingly, even if the bus bridge 207 is included, the order guarantee circuit 210 guarantees an order in which the memory 200 is accessed.

A configuration has been described in which an order guarantee circuit operates using an interrupt signal of a bus master as a hardware trigger (order guarantee control implemented by hardware). In a fifth embodiment, order guarantee control using an interrupt signal under software control (software trigger) will be described. In order to allow an order guarantee circuit to operate based on a software trigger, a configuration is made by incorporating software for allowing a software trigger signal to be generated in the circuit configurations in the embodiment 1 to the embodiment 4. A control program for allowing the CPU to generate the above software trigger signal is prepared in the system. When described using, for example, FIG. 1, the configuration in the fifth embodiment is such that the bus master 203 outputs an interrupt signal 216 to the CPU 202 instead of to the order guarantee circuit 210. The CPU 202 is configured to, upon receiving the interrupt signal 216, output a trigger signal to the order guarantee circuit 210 in accordance with a control program. This point is a difference between the fifth embodiment, which is implemented by software, and the first embodiment, which is implemented by hardware.

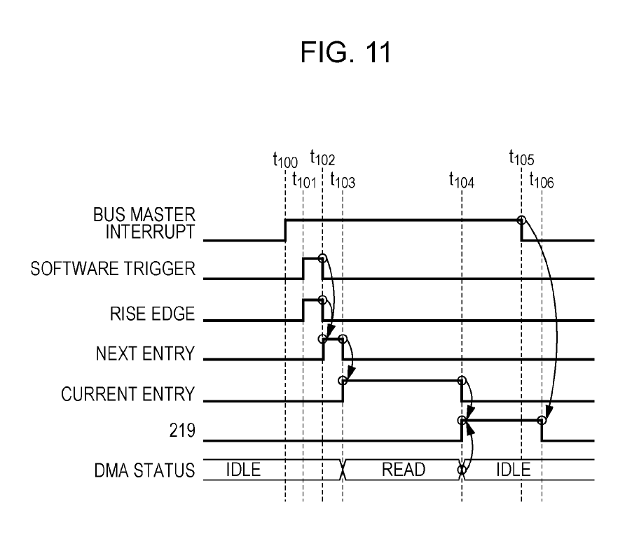

FIG. 11 is a diagram depicting the timing of the operation of an order guarantee circuit. Also in FIG. 11, the internal signals of the order guarantee circuit are similar to those in FIG. 3. After outputting a write request to a bus, the bus master 203 outputs a bus master interrupt signal to the CPU 202 (timing t100). The CPU 202 outputs a software trigger signal in accordance with this notification (t101 to t102). The order guarantee circuit 210 performs an operation in a manner similar to that in the processing in FIG. 3 in accordance with the software trigger signal, and enters a read state from an idle state (t103) to execute a read DMA operation. When a read is completed, an interrupt signal 219 is output (t104). In this way, the order guarantee circuit 210 receives an interrupt signal from the CPU 202, thereby executing a read operation. In a configuration in which an order guarantee circuit performs an operation upon receiving a notification from two bus masters, one interrupt signal may be used as a hardware trigger and the other interrupt signal may be used as a software trigger. In this case, a configuration may be provided in which a read DMA operation corresponding to an earlier input interrupt signal is performed. Explanation of Inkjet Recording Apparatus

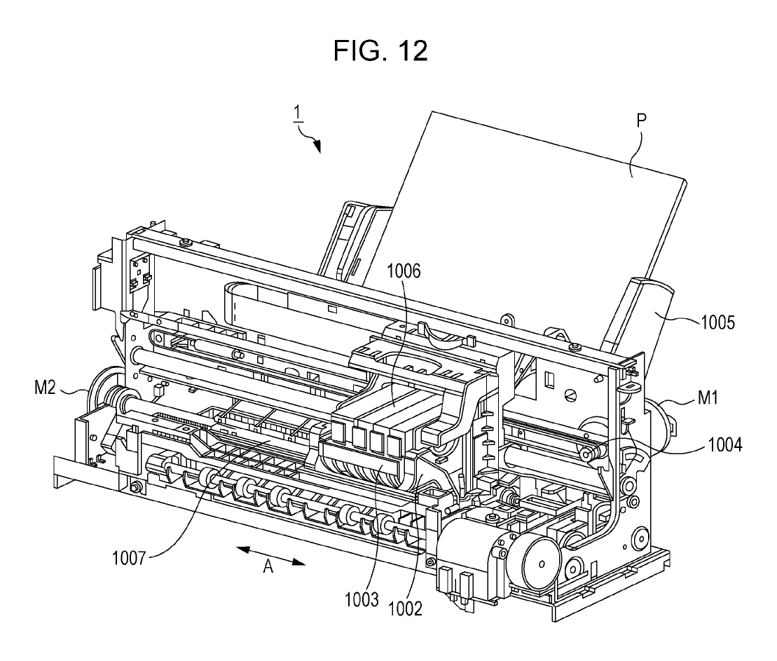

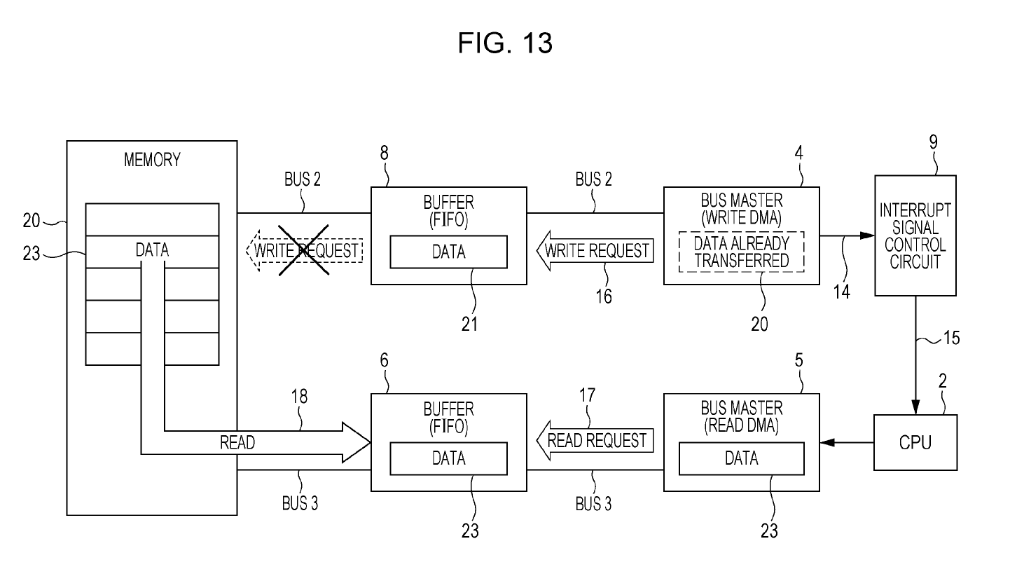

Next, an inkjet recording apparatus applied to the above-described embodiments will be described. FIG. 12 is a perspective view of an inkjet recording apparatus 1. The inkjet recording apparatus (hereinafter referred to as the recording apparatus) has mounted on a carriage 1002 a recording head 3 that performs recording by ejecting ink in accordance with an inkjet method. The driving force that is generated by a carriage motor M1 is transmitted to the carriage 1002 from a transmission mechanism 1004, and the carriage 2 is allowed to reciprocate in a direction indicated by an arrow A. During recording, a recording medium P, for example, recording paper, is fed by a paper feed mechanism 1005, and is conveyed to a recording position. Ink is ejected onto the recording medium P from the recording head 3 to perform recording at the recording position. Numeral 1007 denotes a conveying roller that conveys the recording medium P, and is driven by a conveying motor M2.

In addition to the recording head 1003, ink cartridges 1006 that contain ink to be supplied to the recording head 3 are also attached to the carriage 1002 of the recording apparatus 1. The ink cartridges 1006 are attachable to and detachable from the carriage 1002.

The recording apparatus 1 illustrated in FIG. 12 is capable of performing color recording, and therefore four ink cartridges respectively containing inks of magenta (M), cyan (C), yellow (Y), and black (K) are mounted on the carriage 2. The four ink cartridges are independently attachable and detachable.

Now, required electrical connection between the carriage 1002 and the recording head 1003 can be achieved and maintained by bringing joint surfaces of both members into appropriate contact with each other. The recording head 1003 applies energy in accordance with a recording signal, thereby selectively ejecting inks from a plurality of ejection ports to perform recording. In particular, the recording head 1003 adopts an inkjet method in which ink is ejected by utilizing thermal energy. Thus, the recording head 1003 has an electrothermal transducer to generate thermal energy.

The present invention is not intended to be limited to the foregoing embodiments, and a variety of changes and modifications can be made without departing from the spirit and scope of the present invention. Therefore, the claims which follow are appended in order to clearly define the scope of the present invention.

According to a configuration of the present invention, when a circuit device connected to a certain bus among a plurality of buses writes data to a memory and a circuit device connected to another bus reads the data from the memory, this order can be guaranteed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of International Patent Application No. PCT/JP2011/079586, filed Dec. 21, 2011, hereby incorporated by reference herein in its entirety.

1. An information processing apparatus including a memory control unit that is connected to a first bus and a second bus and that controls writing of data to a memory and reading of data from the memory, the information processing apparatus comprising:
a control unit that controls the information processing apparatus;
a first circuit device that is connected to the first bus and that outputs a data write request to the memory control unit and outputs a notification signal;
a second circuit device that is connected to the first bus and that outputs a data read request to the memory control unit in accordance with the notification signal and outputs an interrupt signal to the control unit in accordance with a response to the data read request; and
a third circuit device that is connected to the second bus and that outputs a data read request stored in the memory to the memory control unit in accordance with an instruction from the control unit to which the interrupt signal has been input.

2. The information processing apparatus according to claim 1, further comprising a fourth circuit device that is connected to the first bus and that outputs a data write request to the memory control unit and outputs a second notification signal to the second circuit device,
wherein the second circuit device outputs a data read request to the memory control unit in accordance with each of the notification signal and the second notification signal.

3. The information processing apparatus according to claim 1, wherein, if a request output to the first bus is arbitrated with a state maintained in which a priority of the first circuit device is higher than a priority of the second circuit device, the second circuit device outputs a read request once.

4. The information processing apparatus according to claim 1, wherein, if a request output to the first bus is arbitrated using a round-robin method, the second circuit device outputs a read request at least twice.

5. The information processing apparatus according to claim 3, wherein the memory control unit accesses the first bus and the second bus in a time division manner.

6. The information processing apparatus according to claim 1, wherein
the control unit receives the notification signal from the first circuit device, and outputs a third notification signal to the second circuit device, and
the second circuit device outputs a data read request to the memory control unit in accordance with the third notification signal, and outputs an interrupt signal to the control unit in accordance with a response to the data read request.

7. A recording apparatus comprising the information processing apparatus according to claim 1, and a recording head.
